(19) United States
(12) Patent Application Publication
(10) Pub. No.: US 2001/0034558 A1
(43) Pub. Date: Oct. 25, 2001

(54) Dynamically adaptive scheduler

(75) Inventor: Edward Sean Hoskins, Longmont, CO (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 09/773,686

(22) Filed: Jan. 31, 2001

Related U.S. Application Data
(60) Provisional application No. 60/181,022, filed on Feb. 8, 2000.

(51) Int. Cl. G05B 11/01

(52) U.S. Cl. 700/13

(57) ABSTRACT

Dynamically scheduling the launch of tasks, each task comprising one or more associated executable actions, each task having an associated next action indicator and an associated next task indicator. Wherein, a first task is launched, an action indicated by the next action indicator associated with the first task is executed, and a task indicated by the next task indicator associated with the first task is launched.

### RELATED APPLICATIONS

This application claims priority of U.S. provisional application Ser. No. 60/181,022, filed Feb. 8, 2000.

### FIELD OF THE INVENTION

This application relates generally to task scheduling and more particularly to dynamically scheduling tasks in a disc drive system.

### BACKGROUND OF THE INVENTION

Task scheduling involves launching or executing a number of tasks either in a predetermined order (static task scheduling) or in an order which is dependent on the results or inputs to a task scheduling system as that system is being carried out (dynamic task scheduling). Task scheduling may also be carried out “by hand,” such as with a bookkeeping or ledger system, or with tokens representing next task and next action indicators. For example, the order of tasks to be performed by a worker in a trucking company may be determined with the use of a task scheduling ledger either manually or with the use of a handheld computing device. However, the more common use of task scheduling is in relationship to scheduling the execution of commands within a general purpose or a special purpose computing system. In particular, task scheduling is often used in conjunction with or as a means for implementing commands in the processor of a multitasking computer system.

Multitasking provides a microprocessor the ability to seemingly work on a number of tasks simultaneously. This is accomplished by quickly switching from one task to another, thus giving the appearance that the microprocessor is executing all of the tasks at the same time. The process of switching from one task to another is often referred to as context switching. Context switching is commonly carried out by a scheduler/dispatcher, which provides a mechanism for the acceptance of tasks into the system and for the allocation of time within the system to execute those tasks.

Multitasking can be either preemptive or cooperative. In cooperative multitasking the scheduler/dispatcher relies on each task to voluntarily relinquish control back to the scheduler so that another task may be run. In preemptive multitasking the scheduler decides which task receives priority, and parcels out slices of microprocessor time to each tasks and/or to portions of each task. In either preemptive or cooperative multitasking, some or all of the tasks will may have their own “context.” That is, each task may have its own priority, set of registers, stack area, program counter, timers, etc. These contexts are saved when a context switch occurs and/or when a system interrupt occurs. The tasks context is then restored when the task is resumed.

One disadvantage of multitasking is that it may introduce time delays into the system as the processor spends some of its time choosing the next task to run and saving and restoring contexts. However, multitasking typically reduces the worst-case time from task submission to task completion compared with a single task system where each task must finish before the next task starts. Additionally, multitasking saves processing time by allocating processor time to one task while another task is in a waiting state.

A number of scheduling methods are known. For example, schedulers may employ a plurality of queues of different priorities. Schedulers may assign tasks based upon user determined priorities. Simple schedulers may employ a first-come first-served method, or shortest-task-first method of ordering tasks.

Multitasking systems may be used in any number of computing environments. One particular use of multitasking is in the microprocessor or digital signal processor within a digital data storage disc drive. Typically, a disc drive contains a microprocessor, internal memory, and other structures that control the functioning of the drive. The microprocessor may perform one or more of the following tasks: controlling the disc spin motor, controlling the movement of the actuator assembly to position read/write transducers over the storage media on the disc, managing the timing of read/write operations, implementing power management features, and coordinating and integrating the flow of information through the disc drive interface to and from a host computer, etc. If the disc drive microprocessor provides multitasking, the microprocessor will typically employ a scheduler/dispatcher to order and execute the tasks.

Often times, the above mentioned tasks are performed in the disc drive by a digital signal processor (DSP). DSP are often selected for their low cost and high computational speeds. However, DSPs traditionally have inferior stack support and poor interrupt and context switch latency.

It is with respect to these considerations and others that the present invention has been developed.

### SUMMARY OF THE INVENTION

One aspect of the present invention relates to a unique system for scheduling the order of launch of a plurality of tasks. In accordance with this aspect of the present invention, a task comprises one or more executable actions. Each of the tasks has an associated next action indicator and an associated next task indicator. The next action indicator indicates the action which is to be executed upon the launch of its associated task and the next task indicator indicates the task which is to be launched upon the completion of the task to which it is associated. Preferably, one or more of the actions in a task are operable to modify the next action indicator of another task or the task to which they are associated. Likewise, preferably one or more of the actions are operable to modify a next task indicator of another task or the task to which they are associated.

Another aspect of the present invention relates to a method for dynamically scheduling the launch of a plurality of tasks, wherein each task comprising one or more associated executable actions and wherein each task has an associated next action indicator and an associated next task indicator. The steps of the method include launching a first task, executing an action indicated by the next action indicator associated with the first task, and launching a second task indicated by the next task indicator associated with the first task.

Yet another aspect of the present invention relates to a computer-readable medium having a data structure stored thereon. The data structure preferably comprises a plurality of tasks, a plurality of next action indicators, and a plurality of next task indicators, all of which are stored on the computer-readable medium. Each of the next action indicators and each of the next task indicators being associated with a respective task. Each next action indicator indicating an action to be executed upon the launch of its respective task by a round robin task scheduler and each next task indicator indicating the task which is to be launched after the completion of its respective task by a round robin task scheduler.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive assembly in accordance with the present invention with the head disc assembly cover partially broken away and with portions of the discs broken away.

FIG. 2 illustrates an operational flow of a task scheduler according to an example embodiment of the present invention.

FIG. 3 is a simplified functional block diagram of the disc drive shown in FIG. 2.

FIG. 4 illustrates an operational flow of a disc drive scheduler according to an example embodiment of the present invention.

FIG. 5 illustrates an operational flow of a computer program embodiment of the disc drive scheduler shown in FIG. 4.

FIG. 6 illustrates an alternative operational flow of a computer program embodiment of the disc drive scheduler shown in FIG. 4.

FIGS. 7-1 and 7-2 illustrate yet another alternative operational flow of a computer program embodiment of the disc drive scheduler shown in FIG. 4.

### DETAILED DESCRIPTION

In general, the present disclosure describes methods and systems for scheduling and and/or dispatching a plurality of tasks. More particularly, the present disclosure describes a scheduler/dispatcher (scheduler) for scheduling a plurality of tasks within a multiprocessing computing device. More particularly still, the present disclosure describes a computer program for scheduling and dispatching a plurality of tasks in a microprocessor in a disc drive device.

The following is description of an exemplary operating environment embodiment for the present invention. In particular, reference is made to practicing the task scheduler of the present invention with respect to a computing device in a disc drive system such as disc drive 100. It is to be understood that other embodiments, such as other computing environments and non-disc drive related environments are contemplated and may be utilized without departing from the scope of the present invention.

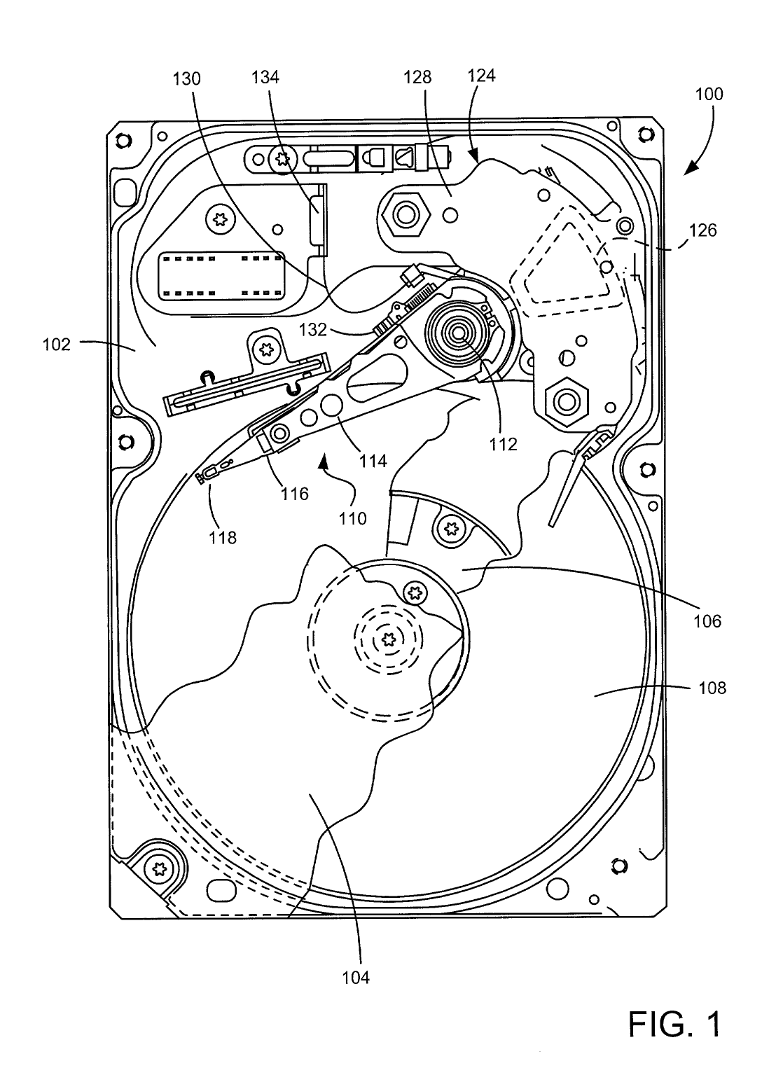

Referring to FIG. 1, a disc drive 100 in which the methods and system of the present invention may be practiced is shown. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a head 118 which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base 102 to a disc drive printed circuit board (not shown) mounted to the bottom side of the disc drive 100.

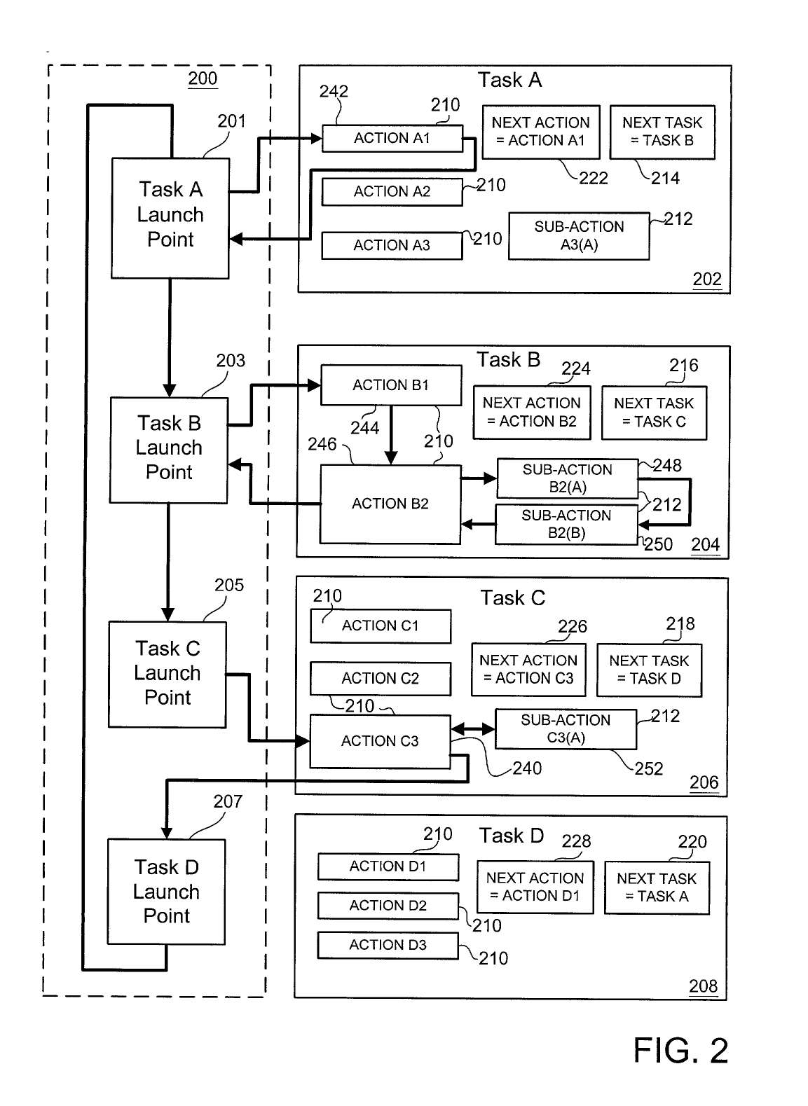

FIG. 2 shows a general, environment independent embodiment of a task scheduler in accordance with the present invention. FIG. 2 illustrates some of the basic elements and operational parameters of a task scheduler in accordance with the present invention. These basic elements and operational parameters may be implemented in a number of computer and non-computer related environments, some of which are described in detail below.

As shown in FIG. 2, a task scheduler 200 includes a plurality of task launch points 201, 203, 205, and 207. As also shown in FIG. 2, each of the task launch points 202, 203, 205, and 207 has an associated task: task A 202, task B 204, task C 206, and task D 208, respectively. While the task scheduler 200 of FIG. 2 is shown having four task launch points 201, 203, 205, and 207, each of which having an associated task 202, 204, 206, and 208, respectively, it is to be understood that the task scheduler 200 may include any number of launch points and associated tasks.

As shown in FIG. 2, each task 202, 204, 206, and 208 comprises one or more associated actions 210. Each individual task 202, 204, 206, and 208 may include only actions 410 which are exclusive to that task. Additionally, although not specifically shown in FIG. 2, individual tasks 202, 204, 206, or 208 may share one or more actions 210. As used herein the term action describes an event or a series of events or commands which may be executed by scheduler 200. Preferably, actions are uninterruptible processes which constitute either a logical grouping of activities (e.g. jobs or work) or as much work as can be done while another task or action is being completed.

As also shown in FIG. 2, each action 210 may include one or more associated subactions 212. Each individual action 210 may include only sub-actions 212 which are exclusive to that action 210 or individual actions 210 may share one or more sub-actions 212. The term sub-action is used herein to describe an event or a series of events which may be executed by or within an action 210. Any of the actions 210 within a task 202, 204, 206, or 208 may be executed by the task launch point 201, 203, 205, or 207 associated with that task. Additionally, any action 210 may execute any other action 210 within its task 202, 204, 206, or 208. Finally, any action may execute any associated sub-action 212.

Each task 202, 204, 206, and 208 of the scheduler 200 has an associated next task indicator 214, 216, 218, and 220, respectively. Each next task indicator 214, 216, 218, and 220 indicates the next task which is to be implemented upon completion of the task to which the next task indicator is associated. Additionally, each of the tasks 202, 204, 206, and 208 of the scheduler 200 includes a next action indicator 222, 224, 226, and 228, respectively. Each next action indicator 222, 224, 226, and 228 indicates which of the actions 210 in the task to which the next action indicator is associated is to be executed when the associated task is launched.

Next task indicators 214, 216, 218, and 220 and next action indicators 222, 224, 226, and 228, may be dynamically modified by actions 210 during the execution of the actions 210. Any action 210 may modify any next action indicator 222, 224, 226, and 228, including the next action indicator associated with the task to which the action is associated. Any action 210 may also modify any next task indicator 214, 216, 218, and 220, including the next task indicator associated with the task to which the action is associated. In this way, the order of launch of the tasks 202, 204, 206, and 208 and the order of execution of the actions 210, may be dynamically modified during operation of the scheduler 200, thus allowing a great deal of flexibility in managing the operational flow of the scheduler 200. Additionally, any or all of the next task indicators 214, 216, 218, and 220 and/or the next action indicators 222, 224, 226, and 228, may be set and remained fixed throughout the operation of the scheduler 200.

The operational flow from one task launch point 201, 203, 205, or 207 to another task launch point may occur in one of two ways, either directly from one task launch point 201, 203, 205, or 207 to another task launch point, or from one task launch point to another task launch point via an action 210. For example, as shown in FIG. 2, the operational flow from task launch point 201 to task launch point 203 occurs directly. Alternatively, the operational flow from task launch point 205 to task launch point 207 occurs via action C3 240. A better understanding of the manner in which the operational flow of the scheduler 200 may be controlled may be had with reference to the following example.

FIG. 2 illustrates one example of a possible operational flow of the scheduler 200. As shown, the next task indicator 214 associated with task A 202 is set to task B 204, the next task indicator 216 associated with task B 204 is set to task C 206, the next task indicator 218 associated with task C 206 is set to task D 208, and the next task indicator 220 associated with task D 208 is set to task A 202. As also shown in FIG. 2, the next action indicator 222 associated with task A 202 is set to action A1 240, the next action indicator 224 associated with task B 204 is set to action B1 242, the next action indicator 226 associated with task C 206 is set to action C3 244, and the next action indicator 228 associated with task D 208 is set to task A 202.

In this example, task A launch point 201 implements action A1 242 of task A 202. This occurs because the next action indicator 222 associated with task A 202 indicates action A1 242 as the action to be executed upon launch of task A 202 by the scheduler 200. At the end of the execution of action A1 242, the operational flow of the scheduler 200 is directed back to task launch point 201 by action A1 242. This occurs because action A1 242 includes a command or direction (not shown) directing the operational flow of scheduler 200 back to task launch point 201.

The operational flow of the scheduler 200 then flows from task launch point 201 to task launch point 203. This occurs because the next task indicator 214 associated with task A 202 indicates task B 204 as the task to be implemented after the completion of task A 202. Task launch point 203 then executes action B1 244 of task B 204, which in turn executes action B2 246. Launch point 203 executes action B1 244 because the next action indicator 224 associated with task B 204 indicates action B1 244 as the action to be executed upon launch of task B 204 by scheduler 200. Action B1 244 executes action B2 246 due to a command or direction within action B2 246 requiring the execution of action B2 246 at the completion of action B1 244. Action B2 246 then executes sub-action B2(a) 248 and sub-action B2(a) 250 in order as a part of the operation of action B2 246. At the conclusion of the execution of sub-actions B2(a) and B2(b), action B2 246 directs the operational flow of the scheduler 200 back to task B launch point 203 from action B2 246. This occurs because action B2 246 includes a command (not shown) directing the operational flow of the scheduler 200 back to task launch point 203.

The operational flow of the scheduler 200 then flows from task B launch point 203 to task C launch point 205. This occurs because the next task indicator 216 associated with task B 204 indicates task C 206 as the task to be implemented after the completion of task B 204. Task launch point 205 then executes action C3 240. This occurs because the next action indicator 226 associated with task C 206 indicates action C3 240 as the action to be executed upon launch of task C 206 by scheduler 200. Action C3 240 then performs sub-action C3(a) 252 as a part of the operation of action C3 240.

At the conclusion of sub-action C3(a) 252, action C3 240 directs the operational flow of the scheduler 200 to task D launch point 207. This occurs because action C3 240 includes a command or direction which directs the operational flow of the schedule 200 to the task indicated by next task indicator 218 of task C 206. In this way, the operational flow of the scheduler 200 may flow directly from an action to a task without returning to the task launch point which launched the action. Finally, the operational flow of the scheduler 200 proceeds directly from task D launch point 207 to task A launch point 201. This occurs because the next action indicator 228 associated with task D 208 indicates task A 201 as the task to be executed after the completion of task D 208, in effect bypassing the action 210 of task D 208.

It is to be understood that the above example 209 of an operational flow of the scheduler 200 is but one example of a possible operational flow of the scheduler 200. Any number of possible operational flows may occur which are consistent with the basic operational parameters of the scheduler 200 as laid out above. Additionally, it is to be understood that the scheduler 200 may be implemented in either a computer or a non-computer relate environment. For example, the scheduler 200 may be implemented by hand, such as with a bookkeeping or ledger system, or with tokens representing next task and next action indicators. Furthermore, the scheduler of the present invention may be implemented in a computing device as described below.

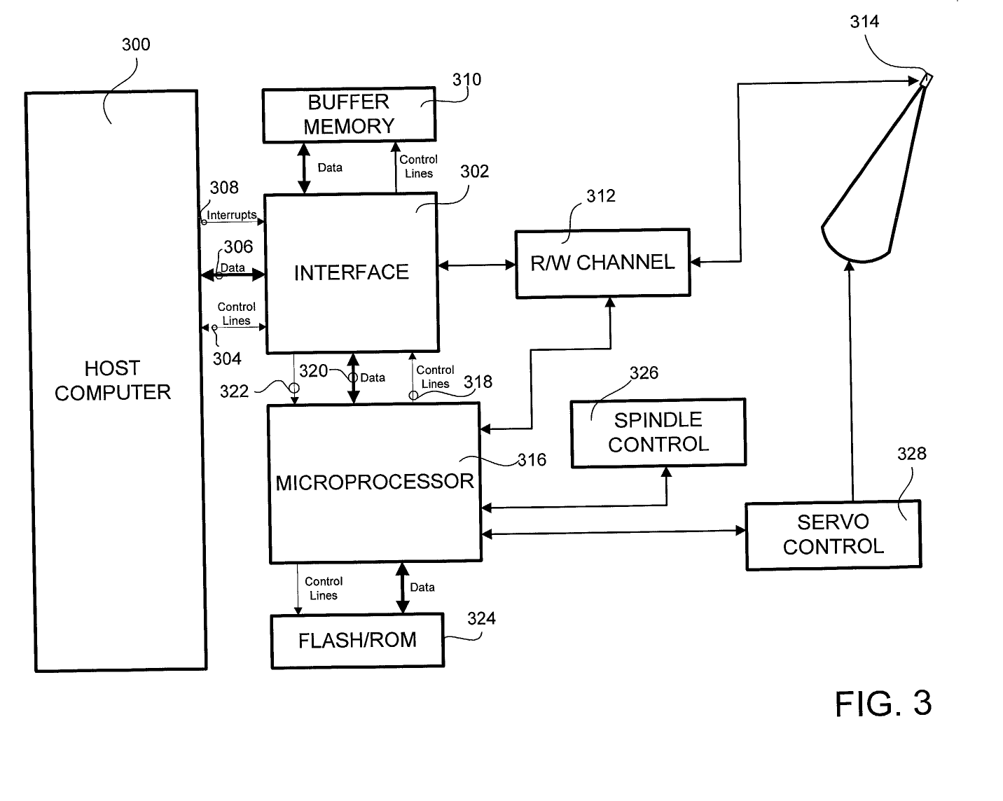

Referring now to FIG. 3, shown therein is a functional block diagram of the disc drive 200 of FIG. 2, generally showing the main functional circuits which are typically resident on a disc drive printed circuit board and which are used to control the operation of the disc drive 200. As shown in FIG. 3, the host computer 300 is operably connected to an interface application specific integrated circuit (interface) 302 via control lines 304, data lines 306, and interrupt lines 308. The interface 302 typically includes an associated buffer 310 which facilitates high speed data transfer between the host computer 300 and the disc drive 200. Data to be written to the disc drive 200 are passed from the host computer to the interface 302 and then to a read/write channel 312, which encodes and serializes the data and provides the requisite write current signals to the heads 314. To retrieve data that has been previously stored by the disc drive 200, read signals are generated by the heads 314 and provided to the read/write channel 312, which performs decoding and error detection and correction operations and outputs the retrieved data to the interface 302 for subsequent transfer to the host computer 300. Such operations of the disc drive 200 are well known in the art and are discussed, for example, in U.S. Pat. No. 5,276,662 issued Jan. 4, 1994 to Shaver et al.

As also shown in FIG. 3, a microprocessor 316 is operably connected to the interface 302 via control lines 318, data lines 320, and interrupt lines 322. The microprocessor 316 provides top level communication and control for the disc drive 100 in conjunction with programming for the microprocessor 316 which is typically stored in a microprocessor memory (MEM) 324. The MEM 324 can include random access memory (RAM), read only memory (ROM) and other sources of resident memory for the microprocessor 316. Additionally, the microprocessor 316 provides control signals for spindle control 326, and servo control 328.

In an exemplary embodiment of the present invention, a disc drive scheduler 400 is employed to schedule and dispatch tasks in a microprocessor, such as microprocessor 316 of the disc drive 100 (FIG. 3). The logical operations of the disc drive scheduler 400 are implemented (1) as a sequence of microprocessor 316 implemented acts or program modules running on the microprocessor 316 and/or (2) as interconnected machine logic circuits or circuit modules within the disc drive 100. The implementation is a matter of choice dependent on the performance requirements of the disc drive 100. Accordingly, the logical operations making up the embodiments of the disc drive scheduler 400 described herein are referred to variously as operations, structural devices, acts or modules. While the following embodiments of the disc drive scheduler 400 are discussed as being implemented as software, it will be recognized by one skilled in the art that these operations, structural devices, acts and modules may be implemented in software, in firmware, in special purpose digital logic, and any combination thereof without deviating from the spirit and scope of the present invention as recited within the claims attached hereto.

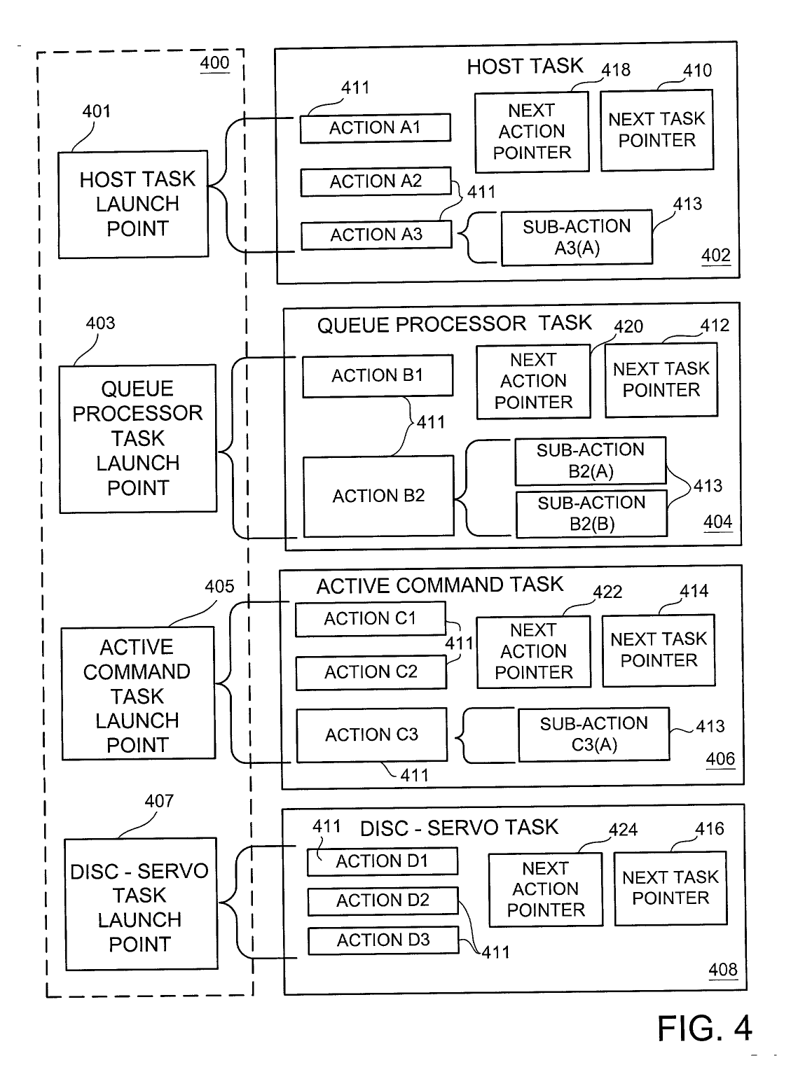

In one embodiment of the disc drive scheduler 400, shown in FIG. 4, the disc drive scheduler 400 comprises a software program or routine for scheduling a plurality of tasks within a microprocessor in a disc drive, such as microprocessor 316 (FIG. 3). In this embodiment of the invention, scheduler 400 may comprise any number of task launch points and associated tasks. However, for illustration purposes, the scheduler 400 is shown including four task launch points 401, 403, 405, and 407, each of which corresponds to an associated task 402, 404, 406, and 408, respectively. It is to be understood that the disc drive scheduler 400 may include more or fewer than the four task launch points and the four associated tasks shown and discussed with respect to FIGS. 4-7. Additionally, as described in greater detail below, the scheduler 400 is operable to add and remove tasks dynamically.

The four tasks discussed herein for implementation in a disc drive scheduler 400 include: a host task 402, a queue processor task 404, an active command task 406, and a disk-servo task 408. The host task 402 may handle all non-timing critical, host related functions, such as cache hit searches for reads of the discs of the disc drive and cache collision detection for writes to the discs of the disc drive. Additionally, the host task 402 may provide write commands to the queue processor task 404 and handle host resets for delayed writes to the discs. The host task 402 may also prepare the queue process task 404 for writes and the disc-servo task 408 for reads.

The queue processor task 404 may manage one or more queues which is/are used for the entry, sorting, and dispatching of commands to the active command task 406. The active command task 406 may handle the data management of the disc drive. That is, the flow of data into and out of, for example, buffer memory 310 of the disc drive 100.

The disc servo task 408 may handle all media access. The disc servo task 408 may initialize and start a formatter for performing the low level, time critical reading and writing of the magnetic media and a media manager for maintaining the read/write heads 118 of the disc drive 100 in proper circumferential orientation on the disc relative to an index mark on the discs 108. Additionally, the disc servo task 408 may launch a disk interrupt task and a servo complete routine, both of which are described in more detail below. The disc servo task 408 may recover from media errors and servo errors by changing parameters in the logic which decodes data on the discs. Finally, the disc servo task 408 may serve to reissue failed seek commands and spin up the disc drive when it has spun down.

It should be understood that the following descriptions of the functions of the tasks 402, 404, 406, and 408 is for illustration purposes. The disc drive task scheduler 400 may include the tasks as described or may include any number of other tasks having different functions. However, it is preferable that the tasks scheduled by the disc drive task scheduler are cooperative or non-preemptive.

All of the tasks of the disc drive scheduler 400 are preferably cooperative and cannot be preempted by another task within the scheduler. As such, no tasks in the scheduler 400 requires a context save when being implemented by scheduler 400, thus reducing the switching time between one task and another and allowing quicker response time to time critical events then would occur if the tasks were preemptive.

Each of the tasks 402, 404, 406, and 408 of the task scheduler 400 has an associated next task pointer 410, 412, 414, and 416, respectively. These next task pointers indicate, or point to the starting address of the next task 402, 404, 406, or 408 which is to be launched upon completion of the task to which the next task pointer is associated. Additionally, each task 402, 404, 406, and 408 of the task scheduler 400 has an associated next action pointer 418, 420, 422, and 424, respectively. The next action pointers indicate, or point to the starting address of the action which is to be executed upon entry into the task to which the next action pointer is associated. Each task 402, 404, 406, and 408 in the scheduler 400 preferably defines and keeps its own local variables. There are no global variables in the scheduler 400. In this way, greater efficiency is achieved in the scheduler 400, as processor time and resources are not spent saving task contexts. Allocation of memory space for the next task pointers 410, 412, 414, and 416 and the next action pointers 418, 420, 422, and 424, and the various local variables of the actions 411, preferably occurs at the compile time of scheduler 400. Various methods of program compilation and memory allocation are well known in the art. The method used to allocate memory with respect to scheduler 400 is dependent upon the type of processor in which scheduler 400 is implemented.

As shown in FIG. 4, each task 402, 404, 406, and 408 preferably comprises one or more associated actions 411, which may be executed upon launch of a task 402, 404, 406, or 408 by the scheduler 400. Additionally, each of the actions 411 may execute one or more subactions 413. It is to be understood that the disc drive scheduler 400 may include or execute more or fewer sub-task than the sub-tasks shown in FIG. 4, depending on the requirements of a particular disc drive 100.

In addition to the cooperative tasks implemented by the scheduler 400, the disc drive microprocessor 316 may implement preemptive routines which interact with the tasks of the scheduler 400. For example, the disc drive microprocessor 316 preferably includes a host interrupt routine, a disc interrupt routine, and a servo complete routine. These preemptive routines (not shown) may interact with, be called by, and/or call one or more of the four tasks of the scheduler 400. The host interrupt routine preferably performs the function of determining if commands coming into the disc drive 100 are candidates for queuing, and, if so, sets the next action pointer within the host task such that the incoming command is executed the next time the host task is called. The host interrupt task also preferably determines if a reset command is pending and, if so, launches the appropriate action in host task 402.

The disc interrupt routine preferably determines when the disc formatter has stopped and calculates how many data blocks have been written or read and if any errors occurred in reading or writing the data blocks. The servo complete routine may operate to start a disc drive formatter on the first possible servo frame after a servo interrupt has completed.

Operation of an embodiment of the disc drive scheduler 400 occurs as follows. At the start up of the disc drive a boot/initialization process is preferably utilized to prepare the disc drive for operation and to initialize the scheduler 400. At the initialization of the scheduler 400, the next task pointer 410 associated with the host task 402 is set to the address of the queue processor task launch point 403, the next task pointer 412 associated with the queue processor task 402 is set to the address of the active command task launch point 405, the next task pointer 414 associated with the active command task 402 is set to the address of the disk servo task launch point 407, and the next task pointer 416 associated with the disk servo task 402 is set to the address of the host task launch point 401.

Additionally, the next action pointer 418 associated with host task 402 is set to the address of the queue processor task launch point 403, the task next action pointer 420 associated with queue processor task 404 is set to the address of the active command task launch point 405, the active command task next action pointer 422 is set to the address of the disk servo task launch point 407, and the disk servo task next action pointer 424 is set to the address of the host task launch point 401. In this way, the scheduler 400 is initially set in an idle state wherein no actions are being executed and the operational flow of the scheduler 400 is operating in a loop moving from the host task launch point 401, to the queue processor task launch point 403, to the active command task launch point 405, to the disc servo task launch point 407, then back to the host task launch point 401, and so on in a circular manner.

When a read or a write command is received by interface 244 (FIG. 3), an interrupt is sent over the interrupt line 262 to the microprocessor 316, thus initializing the host interrupt routine 426. The host interrupt routine 426 then prepares the host task 402 for reception of a command from the interface 244 by setting the next action pointer 418 associated with the host task 402 to the appropriate action for the command which is to be received. When the host task 402 is next launched by the host task launch point 401, the action at the address specified by the next action pointer 418 associated with the host task is then executed. The action which is being executed may then modify the next action pointers 418, 420, 422, and/or 424 associated with the various task 402, 404, 406, and 408, such that execution of the command received from the interface 244 is carried out by the scheduler 400.

For example, when a host task action, such as action A1 460 (FIG. 4), is being executed, the action may modify the next action pointer 420 associated with the queue processor task 404 so that a particular action is executed by the queue processor task launch point 403. Additionally, the executed host task action A1 460 may modify the next action pointers 418, 420, 422, and/or 424 associated with any tasks 402, 404, 406, and 408, including its own next action pointer 418, so that execution of the command received from the interface 244 is carried out by the scheduler 400.

As each of the other tasks 404, 406, and 408 are launched by their respective task launch points within the scheduler 400, they may modify the next action pointers 418, 420, 422, and/or 424 associated with any of the tasks 402, 404, 406, and 408, including the next action pointer associated with their own task, so that execution of the command received from the interface 244 is carried out by the scheduler 400.

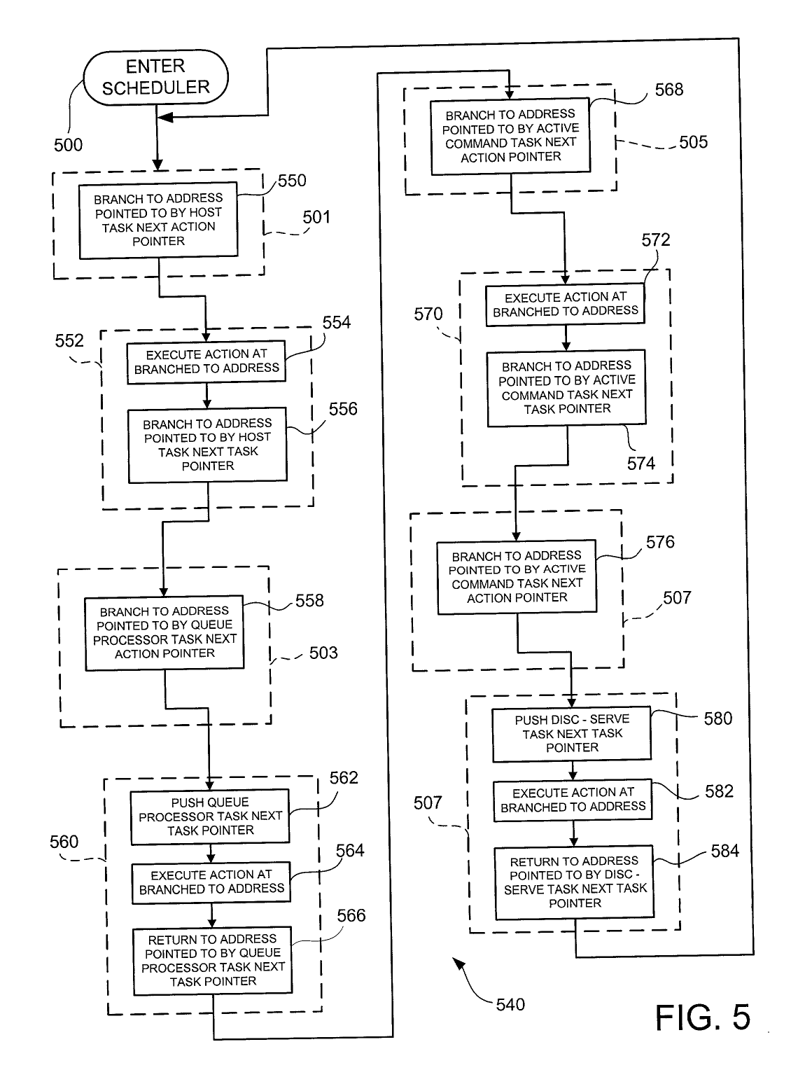

In a first embodiment of the disc drive scheduler 400, the scheduler comprises a computer program or routine which is functional to operate on a disc drive microprocessor, such as disc drive microprocessor 316 shown in FIG. 3. FIG. 5 shows an example of a logical flow 540 of a computer program embodiment of the disc drive scheduler 400. In this embodiment of scheduler 400, the task launch points 501, 503, 505, 507 are preferably written in the assemble language of the microprocessor in which the disc drive scheduler 400 program will run. By writing the program code of the task launch points in assembly language, rather than a high level language such as the C programming language, a number of significant advantages are achieved. First, program code written in assembly language will typically run faster on a microprocessor than program code written in a high level language such as C. Second, by writing the code of the task launch points in assembly, a branch instruction rather than a call instruction may used to initiate the various actions of the tasks. By using the branch instruction rather than a call instruction, the execution flow of the scheduler 400 may move directly from an action to a task launch point, without the need to return to the task launch point from which the action was initiated. This allows for dynamic rearranging, or skipping, of the tasks in the scheduler.

For the purposes of the example shown in FIG. 5, entry 500 into the scheduler 400 is shown occurring at the host task launch point 501. Upon entry into the host task launch point 501, a branch operation 550 branches to the address pointed to by a next action pointer 418 associated with the host task 402. In this way the host task launch point 501 “selects” the action 552 of the host task 402 which is to be executed. An execution operation 554 then executes the code of the action located at the addressed branched to by the branch operation 550. The branch operation 556 then branches to the address pointed to by the next task pointer 410 associated with the host task 402. Here, the address branched to by the branch operation 556 is the address of the queue processor task launch point 503.

Upon entry into the queue processor task launch point 503, a branch operation 550 branches to the address pointed to by the next action pointer 420 associated with the queue processor task 404. In this way the queue processor task launch point 501 “selects” the action 560 of the queue processor task 404 which is to be executed. A push operation 562 then pushes the next task pointer associated with the queue processor task 404. An execute operation 564 then executes the code of the action located at the addressed branch to by the branch operation 558. A return operation 566 then returns to the address pointed to by the next task pointer 412 associated with the queue processor task 404. Here, the address returned to by the return operation 566 is the address of the active command task launch point 505.

Upon entry into the active command task launch point 505, a branch operation 568 branches to the address pointed to by the next action pointer 422 associated with the active command task 406. In this way the active command task launch point 505 “selects” the action 570 of the active command task 406 which is to be executed. An execution operation 572 then executes the code of the action located at the addressed branch to by the branch operation 568. The branch operation 574 then branches to the address pointed to by the active command task next task pointer 414. Here, the address branched to by the branch operation 574 is the address of the disc-servo task launch point 507.

Upon entry into the disc-servo task launch point 507, a branch operation 576 branches to the address pointed to by the next action pointer 424 associated with the disc-servo task. In this way the disc-servo task launch point 507 “selects” the action 578 of the disc-servo task which is to be executed. A push operation 580 then pushes the disc-servo task next pointer 416. An execute operation 582 then executes the code of the action located at the addressed branch to by the branch operation 576. A return operation 584 then returns to the address pointed to by the disc-servo task next task pointer 416. Here, the address returned to by the return operation 584 is the address of the host task launch point 501. The operational flow of the scheduler 400 may continue on in the circular manner shown in FIG. 5.

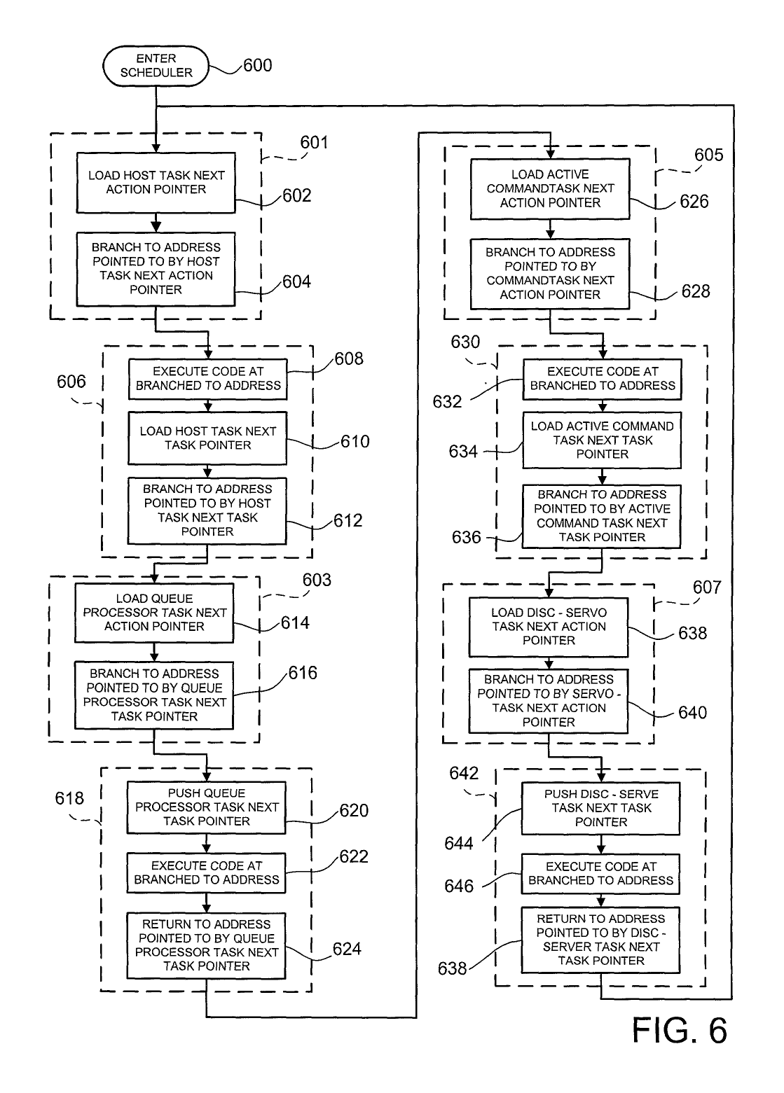

In a second embodiment of the logical flow of the disc drive scheduler 400 is shown in FIG. 6. The second embodiment of the disc drive scheduler 400 shown in FIG. 6 comprises a computer program or routine which is functional to operate on a disc drive microprocessor, wherein the microprocessor is a general or special purpose microprocessor which utilizes a memory based last-in-first-out (LIFO) stack. Similarly to the first embodiment of the scheduler 400 shown in FIG. 5, the second embodiment of the scheduler 400 shown in FIG. 6 includes task launch points 601, 603, 605, and 607, which are written in assembly language and actions and sub-actions which may be written in either assembly language or in a higher level programming language, such as C.

FIG. 6 shows an example of a logical flow 650 of a computer program embodiment of the disc drive scheduler utilizing a memory based last-in-first-out (LIFO) stack. For the purposes of the example shown in FIG. 6, entry 600 into the scheduler 400 is shown occurring at the host task launch point 601. Upon entry into the host task launch point 601, a load operation 602 loads the next action pointer 418 associated with the host task 402. A branch operation 604 then branches to the address pointed to by the next task pointer associated 418 with the host task 402. In this way, the host task launch point 601 “selects” the action 606 of the host task 402 which is to be executed. An execution operation 608 then executes the code of the action located at the addressed branched to by the branch operation 604. A load operation 610 then loads the next task pointer 410 associated with the host task 402. A branch operation 612 then branches to the address pointed to by the next task pointer 410 associated with the host task 402. Here, the address branched to by the branch operation 612 is the address of the queue processor task launch point 603.

Upon entry into the queue processor task launch point 603, a load operation 614 loads the next action pointer 420 associated with the queue processor task 404. A branch operation 616 then branches to the address pointed to by the next action pointer 420 associated with the queue processor task 404. In this way, the queue processor task launch point 603 “selects” the action 618 of the queue processor task 404 which is to be executed. Push operation 620 then pushes the next task pointer 412 associated with the queue processor task 404. An execute operation 622 then executes the code of the action located at the addressed branch to by branch operation 616. A return operation 624 then returns to the address pointed to by the next task pointer 412 associated with the queue processor task 404. Here, the address returned to by return operation 666 is the address of the active command task launch point 605.

Upon entry into the active command task launch point 605, a load operation 626 loads the next action pointer 422 associated with the active command task 406. A branch operation 628 then branches to the address pointed to by the next action pointer 422 associated with the active command task 406. In this way, the active command task launch point 605 “selects” the action 630 of the active command task 406 which is to be executed. An execution operation 632 then executes the code of the action located at the addressed branch to by branch operation 628. A load operation 634 then loads the next task pointer 414 associated with the active command task 406. A branch operation 636 then branches to the address pointed to by the next task pointer 414 associated with the active command task 406. Here, the address branched to by the branch operation 636 is the address of the disc-servo task launch point 607.

Upon entry into disc-servo task launch point 607, a load operation 638 loads the next action pointer 424 associated with the disc-servo task 408. A branch operation 640 then branches to the address pointed to by the next action pointer 424 associated with the disc servo task 408. In this way the disc-servo task launch point 607 “selects” the action 642 of the disc-servo task 408 which is to be executed. A push operation 644 then pushes the next task pointer 416 associated with the disc-servo task 408. An execute operation 646 then executes the code of the action located at the addressed branch to by branch operation 640. A return operation 648 then returns to the address pointed to by the next task pointer 416 associated with the disc-servo task 408. Here, the address returned to by return operation 648 is the address of the host task launch point 601. The operational flow of the scheduler 400 may continue on in the circular manner shown in FIG. 6.

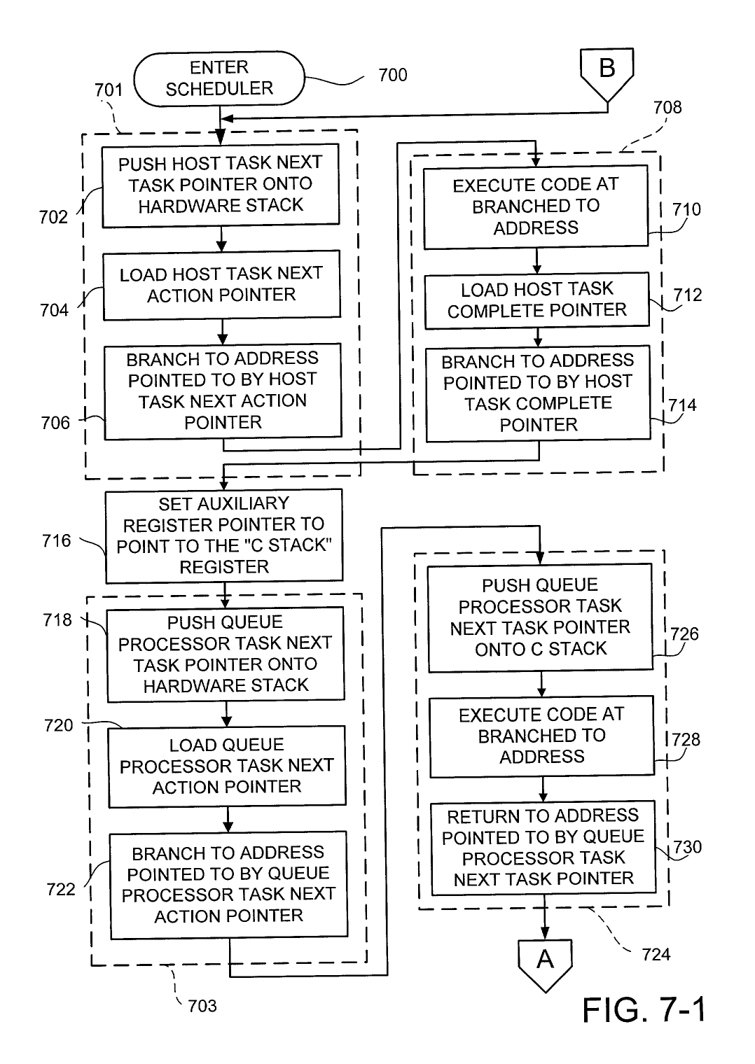

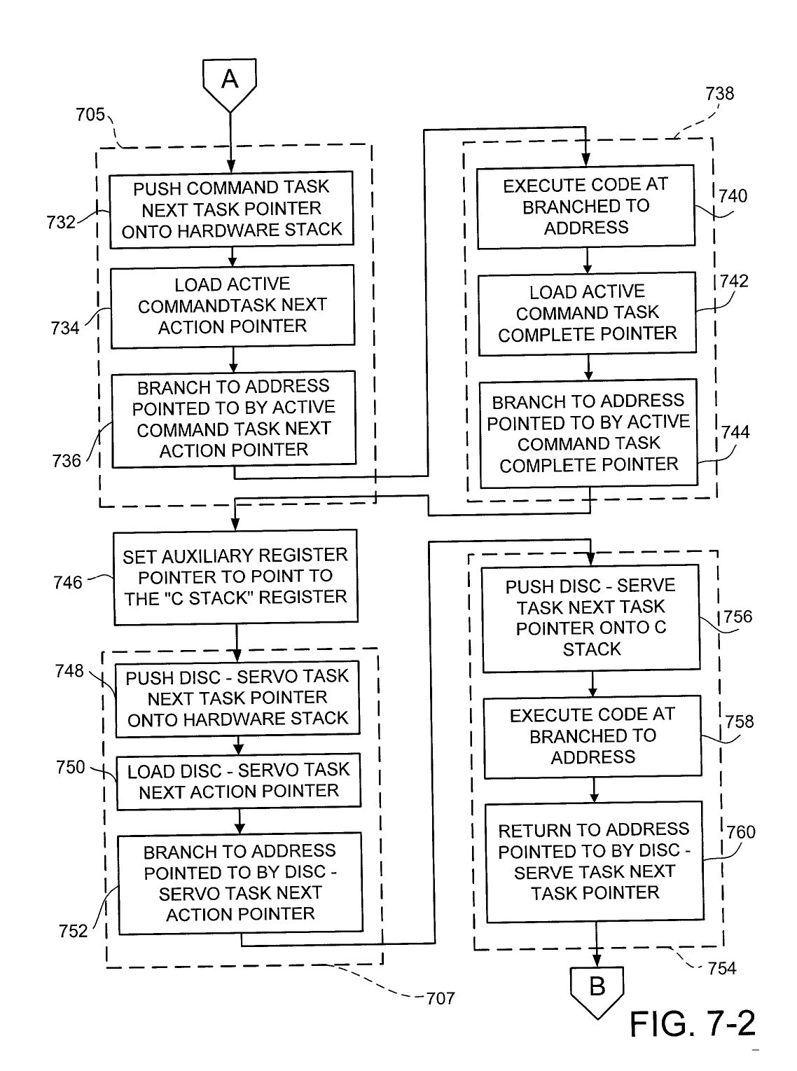

In a third embodiment of disc drive scheduler 400, the logical flow of which is shown in FIGS. 7A and 7B, scheduler 400 comprises a computer program or routine which is functional to operate on a disc drive microprocessor, wherein the microprocessor utilizes a hardware stack. A hardware stack, as that term is used herein, comprises a limited number of hardware registers within a microprocessor which are used as a quickly accessible LIFO stack by the microprocessor, such as in the Texas Instruments Model TMS320C27LP Digital Signal Processor (DSP). DSPs in general, and the Texas Instruments Model TMS320C27LP in particular, offer limited hardware stack support. For example, the hardware stack in the TMS320C27LP is limited to eight words.

Processors which employ limited hardware stacks, such as the Texas Instruments Model TMS320C27LP, often provide what is termed a software stack to accommodate functions which require more than a minimal amount of hardware stack space for their operation. In particular, the “C” code compiler for the Texas Instruments Model TMS320C27LP constructs a software stack called a “C stack, ” which is located in memory. The C stack is a data structure defined in an area of memory accessible to the microprocessor which is used for allocating local variables, passing functions to arguments, saving processor status, saving function return addresses, saving temporary results, and saving registers for functions which are originally written in the C programming language. Upon compilation of the programming code which has been written in the C programming language into assembly language, the compiler for the microprocessor typically includes what is referred to as a “C code wrapper” around the C code which manages the movement of data from the hardware stack to the C stack. In this way, the microprocessor can keep separate and manage code which has been originally written in C from code which has been originally written in assembly language. The concepts involved in the C stack may also be employed in other software stacks, such as software stacks which are used for handling code which is written in other high level languages or for handling assembly code which requires more than the minimal hardware stack space that is provided by the microprocessor. In this embodiment of the present invention, a software stack is also employed for the assembly code.

In microprocessors such as the Texas Instruments Model TMS320C27LP, which employ multiple software stacks, a facility must be provided for indicating the location of the various software stacks in memory. This facility is provided in the Texas Instruments Model TMS320C27LP by a number of auxiliary registers within the microprocessor. Located within one or more of the auxiliary registers are pointers pointing to the various locations in memory where the particular software stacks resides. That is, there is a dedicated register within the microprocessor for each software stack. One of the registers, ar1 in the case of the TMS320C27LP, is used exclusively as a stack pointer to the C stack. Another register within the microprocessor, called the auxiliary register pointer in the Texas Instruments Model TMS320C27LP, indicates, or points to, the auxiliary register which is currently being used by the microprocessor. The pointer in this register is typically modified during execution of a program or routine to point to the software stack currently being used by the microprocessor. As such, it is important that prior to executing a program or routine within the microprocessor which uses a software stack, that the auxiliary register pointer points to the auxiliary register which points to the applicable software stack. Failure to set the auxiliary pointer register to point to the auxiliary register which points to the correct stack before the execution of program code using a software stack, may cause the destruction of data contained in microprocessor memory and the failure of the code which is being executed.

As in the first and second embodiments of the disc drive scheduler shown in FIG. 5 and FIG. 6, respectively, the third embodiment of the disc drive scheduler shown in FIGS. 7A and 7B includes task launch points 701, 703, 705, and 707, which are written in assembly language and actions and sub-actions which may be written in either assembly language or in a higher level programming language, such as C. As such, the programming code of the task launch points and the actions which are written in assembly language are handled by the hardware stack, while the tasks which were originally are written in the C programming language will use the C stack.

While the construct and implementation of a software stack, such as the C stack, is useful in microprocessors utilizing a limited hardware stack, the construct of the C stack also slows down the overall speed of the microprocessor when performing actions or sub-actions of scheduler 400 which have been written in C. One cause for the slowing of the function of the microprocessor involves the constructs of the microprocessor with respect to calling an action requiring the use of the C stack. When an action requiring the use of the C stack is called, the constructs of the microprocessor require that a number of steps be performed with respect to trading data between the hardware stack and the C stack, such as saving various state data to the hardware stack and setting various registers, including resetting the auxiliary pointer register to point to the C stack if the auxiliary pointer register has been changed during the execution of the called action. These steps require a significant amount of processor time to perform, and thus slow down the performance of scheduler 400.

A unique solution to the above noted problems related to the call instruction in the microprocessor, involves the use of a branch instruction in the place of a call instruction when executing an action requiring the C stack. One significant benefit of branching to an action requiring the use of the C stack rather than calling the action, relates to the simplicity, and thus the time taken to perform the branch instruction as opposed to the call instruction. Additionally, the use of a branch instruction will allow the operational flow of scheduler 400 to flow directly from an action requiring the use of the C stack to any of the task launch points without the need to return to the task launch point which called the action.

One problem associated with the use of a branch instruction in this manner relates to the auxiliary register pointer. That is, unlike the call instruction, the branch instruction will not reset the auxiliary register pointer to point to the auxiliary register which points to the C stack if the action which has been branched to has changed the auxiliary register pointer. As noted above, failure to reset the auxiliary register pointer before executing another action requiring the use of the C stack may cause the destruction of data contained in microprocessor memory and the failure of scheduler 400.

Another problem associated with the use of a branch instruction in this manner is that, unlike the call instruction, the branch instruction does not require or use a return address. For example, when an action requiring the use of the C stack is called by a task launch point, such as 701, 703, 705, or 707, the first thing the call instruction does is to pop the return address off of the hardware stack and pushes it onto the C stack. When the action is complete, the call instruction copies the return address from the C stack and pushes it onto the hardware stack. In contrast, when an action requiring the use of the C stack is branched to from a task launch point, the branch instruction jumps to the location in the “C code wrapper” that copies the hardware stack to the C stack. However, when this occurs, the information (address or data) which is present at the top of the hardware stack is copied to the C stack instead of the return address. For this reason, steps must be taken to assure that when a branch operation is used in this manner, the proper address for the next task to be completed by the scheduler 400 is present at the top of the hardware stack when the branch instruction is executed.

FIGS. 7A and 7B show an example of a logical flow of a third computer program embodiment of the disc drive scheduler 400. For the purposes of the example shown in FIGS. 7A and 7B, entry 700 into the scheduler 400 is shown occurring at host task launch point 701. It is assumed in this example that the auxiliary pointer register has been set to point to the C stack auxiliary register prior to the entry into scheduler 400.

Upon entry into the host task launch point 701, a push operation 702 pushes the next task pointer 410 associated with the host task 402 onto the hardware stack. Next, a load operation 704, loads the next action pointer 418 associated with the host task 402. A branch operation 706 then branches to the address of the action 708 pointed to by the next action pointer 418 loaded by the load operation 704. In this way the host task launch point 701 “selects” the action 708 of the host task 402 which is to be executed. In this example, the action selected 708 was originally written in assembly language. As such, this action 708 will not use the C stack, but may alter the auxiliary pointer register, either during its operation or to point to a software stack being used by the assembly action. An execute operation 710 then executes the action located at the address branched to by the branch operation 706. Next, a load operation 712 loads the host task complete pointer. (The host task complete pointer is a pointer to a segment of code in the host task launch point 401 which resets the auxiliary register pointer to point to the C stack auxiliary register.) A branch operation 714 then branches to the address pointed to by the host task complete pointer. Set operation 716 then sets the auxiliary register pointer to point to the C stack auxiliary register. The operational flow of scheduler 400 then proceeds on to queue processor task launch point 703.

Upon entry into the queue processor task launch point 703, a push operation 718 pushes the next action pointer 420 associated with the queue processor task 404 onto the hardware stack. Next, a load operation 720, loads the next action pointer 420 associated with the queue processor task 404. A branch operation 722 then branches to the address of the action 724 pointed to by the next action pointer 420 loaded to by load operation 720. In this way the queue processor task launch point 703 “selects” the action 722 of the queue processor task 404 which is to be executed. In this example, the action selected 722 was originally written in the C programming language. As such, this action 722 will be using the C stack. Push operation 726 then pushes the next task pointer 412 associated with the queue processor task onto the C stack. An execute operation 728 then executes the action located at the address branched to by branch operation 722. Finally, to complete action 724, a return operation 730 returns to the address pointed to by the next task pointer 412 associated with the queue processor task 404. In this case, the next action pointer 412 points to the active command task launch point 705. By branching to the address pointed to by the next action pointer 420, the operational flow of scheduler 400 may proceed on to the task launch point pointed to by the next task pointer 412 which was pushed on to the C stack by push operation 726, thus allowing flexibility in the operational flow of the scheduler 400. If the address pointed to by the next action pointer 412 had been called rather than branched to, the operational flow of scheduler 400 would have necessarily returned to the queue processing task launch point 703. If the next task pointer 412 would not have been pushed onto the C stack after the branch, the operational flow of scheduler 400 would have been indefinite and scheduler 400 would likely have failed.

Upon entry into the active command launch point 705 (FIG. 7B), a push operation 732 pushes the next task pointer 414 associated with the active command task 406 onto the hardware stack. Next, a load operation 734, loads the next action pointer 422 associated with the active command task 406. A branch operation 736 then branches to the address of the action 738 pointed to by the next action pointer 422 loaded to by load operation 734. In this way the active command task launch point 705 “selects” the action 738 of the active command task 468 which is to be executed. In this example, the action selected 738 was originally written in assembly language. As such, this action 738 will not use the C stack, but may alter the auxiliary pointer register. An execute operation 740 then executes the action located at the address branched to by the branch operation 736. Next, a load operation 742 loads the active command task complete pointer. A branch operation 744 then branches to the address pointed to by the active command task complete pointer. A set operation 746 then sets the auxiliary register pointer to point to the C stack auxiliary register. The operational flow of the scheduler 400 then proceeds on to disc-servo task launch point 707.

Upon entry into the disc-servo task launch point 707, a push operation 748 pushes the next task pointer 416 associated with the disc-servo task 408 onto the hardware stack. Next, a load operation 750, loads the next action pointer 424 associated with the disc-servo task 408. A branch operation 752 then branches to the address of the action 754 pointed to by the next action pointer 424 pointed to by the load operation 720. In this way the disc-servo task launch point 707 “selects” the action 752 of the disc-servo task 408 which is to be executed. In this example, the action selected 752 was originally written in the C programming language. As such, this action 752 will be using the C stack. A push operation 756 then pushes the next task pointer 416 associated with the disc-servo task 408 onto the C stack. An execute operation 758 then executes the action located at the address branched to by the branch operation 752. Finally, to complete action 754, a return operation 760 returns to the address pointed to by the next task pointer 416 associated with the disc-servo task 408. In this case, the next action pointer 416 points to the host task launch point 701. The operational flow of the scheduler 400 may continue on in the circular manner shown in FIGS. 7A and 7B.

In summary, in view of the foregoing discussion it will be understood that a first embodiment of the present invention provides a system for scheduling the order of launch of a plurality of tasks (such as 202, 204, 206, and 208) each of the tasks comprising one or more executable actions (such as 210). In this embodiment, the system comprising, a task launcher (such as 200) operative to launch the tasks, a plurality of next action indicators (such as 222, 224, 226, and 228), and a plurality of next task indicators (such as 214, 216, 218, and 220). Each of the next action indicator are associated with a respective task and indicate the action which is to be executed upon the launch of their respective tasks. Each of the next task indicator are associated with a respective task and indicate the task which is to be launched after the completion of their respective tasks. The task launcher is operative to launch the tasks and execute the actions, the task launcher launching the tasks in an order related to the next task indicators of the tasks, the task launcher, upon launch of a task, executing the action indicated by the next action indicator associated with the launched task.

One or more of the actions in the first embodiment of the invention are preferably operable to modify next action indicators and next task indicators. Additionally, the task launcher in this embodiment of the invention preferably comprises a plurality of task launch points (such as 201, 203, 205, and 207), each task launch point being associated with a respective task.

The first embodiment of the present invention preferably further comprising a general purpose computer (such as 316) and a computer readable medium (such as 310) associated with the general purpose computer, wherein each of the tasks comprises one or more computer executable actions stored on the computer readable medium and the task launcher comprises a computer executable routine stored on the computer readable medium.

A further embodiment of the present invention contemplates a method (such as shown in FIG. 5), for dynamically scheduling a plurality of tasks in a data processing system including a processor and an associated memory. Each task preferably comprising one or more associated executable actions stored in the memory, an associated next action indicator which indicates the location in memory of an action associated with the task, an associated task launch point, and an associated next task indicator which indicates the location in memory of the task launch point associated with the task. The method of this embodiment of the present invention preferably comprises the steps of launching a first task (such as 501), executing the action indicated by the next action indicator associated with the first task (such as 552), launching a second task indicated by the next task indicator associated with the first task (such as 503), and executing the action indicated by the next action indicator associated with the second task (such as 560).

In this further embodiment of the present invention (such as shown in FIG. 5), the step of launching a first task may comprise branching to an address pointed to by the next action indicator associated with the first task (such as 550). The step of executing an action indicated by the next action indicator associated with the first task step may comprise executing the action at the address pointed to by the next action indicator associated with the first task (such as 554) and branching to the address pointed to by the next task indicator associated with the first task (such as 556). The step of launching a second task may comprise branching to an address pointed to by the next action indicator associated with the second task (such as 558). Finally, the step of executing an action indicated by the next action indicator associated with the second task step may comprise pushing the next task indicator associated with the second task (such as 562), executing the action at the address pointed to by the next action indicator associated with the second task (such as 564), and returning to the address pointed to by the next task indicator associated with the second task (such as 566).

Alternatively, in this further embodiment of the present invention (such as shown in FIG. 6), the step of launching a first task may comprise loading the next action indicator associated with the first task (such as 602) and branching to the address pointed to by the next action indicator associated with the first task (such as 604). The step of executing action indicated by the next action indicator associated with the first task step may comprise executing the action at the address pointed to by the next action indicator associated with the first task (such as 608), loading the next task indicator associated with the first task (such as 610), and branching to the address pointed to by the next task indicator associated with the first task (such as 612). The step of launching a second task may comprise loading the next action indicator associated with the second task (such as 614) and branching to the address pointed to by the next action indicator associated with the first task (such as 616). Finally, the step of executing action indicated by the next action indicator associated with the second task step may comprise pushing the next task indicator associated with the second task (such as 620), executing the code at the location pointed to by the next action indicator associated with the second task (such as 622), and returning to the address pointed to by the next task indicator associated with the second task (such as 624).

In yet another alternative of this further embodiment of the present invention (such as shown in FIG. 7), the data processing system may further include a hardware stack, a software stack, an auxiliary register pointer, a first task complete function which sets the auxiliary register to indicate use of the software stack, and a first task complete pointer which points to the first task complete function. Additionally, the first task may comprise program code written in assembly language and the second task may comprise program code written in a high level programming language. In this alternative of the further embodiment of the present invention (such as shown in FIG. 7), the step of launching a first task may comprise pushing the next task indicator associated with the first task onto the hardware stack (such as 702), loading the next action pointer associated with the first task (such as 704), and branching to the address pointed to by the next action pointer associated with the first task (such as 706). The step of executing an action indicated by the next action indicator associated with the first task step may comprise executing the action at the address pointed to by the next action indicator associated with the first task (such as 710), loading the first task complete pointer (such as 712), and branching to the address pointed to by the first task complete pointer (such as 714) and executing the first task complete function (such as 716). The step of launching a second task may comprise pushing the next task indicator associated with the second task onto the hardware stack (such as 718), loading the next action pointer associated with the second task (such as 720), branching to the address pointed to by the next action pointer associated with the second task (such as 722). Finally, the step of executing action indicated by the next action indicator associated with the second task step may comprise pushing the next task indicator associated with the second task onto the software stack (such as 726), executing the code at the location pointed to by the next action indicator associated with the second task (such as 728), and returning to the address pointed to by the next task indicator associated with the second task (such as 730).

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, a number of the previously described embodiments of the task scheduler have been described as being embodied in or being capable of being embodied in a computer program or routine which is carried out by a computing device or processor. As is typical, the computer program or routine which embodies the task scheduler may be stored on a computer readable media which is accessible to the computing device or processor, for example buffer memory 310 or flash/ROM 324 (FIG. 3). However, it is to be understood that computer routine or program embodiments of the present invention may be contained on or stored within any computer readable media which is accessible to the computing device or processor upon which the scheduler is carried out. By way of example, and not limitation, computer readable media may comprise computer storage media and communications media. Computer storage media may include volatile and non-volatile, removable and non-removable media implemented in any method or technology for of information such as computer readable instructions, data structures, program modules, or other data. Computer readable media includes, but is not limited to, RAM, ROM, EEPROM, flash memory or other memory technology, or any other medium which can be used to store the desired information and which can be accessed by the computing device or processor. Additionally, computer readable media may include communications media. Communications media typically embodies computer readable instructions, data structures, program modules, or other data in modulated data signals such as carrier wave or other transport mechanisms and includes any information delivery media. Numerous other changes may be made which will readily suggest themselves to those skilled in the art and which are encompassed in the spirit of the invention disclosed and as defined in the appended claims.

What is claimed is:

1. A system for scheduling the order of launch of tasks, the system comprising:
a plurality of tasks, each task comprising one or more executable actions;
a plurality of next task indicators, each next task indicator being associated with a respective task, each next task indicator indicating the task which is to be launched after the completion of its respective task;
a plurality of next action indicators, each next action indicator being associated with a respective task, each next action indicator indicating an action to be executed upon the launch of its respective task; and
a task launcher operative to launch the tasks and execute the actions, the task launcher launching the tasks in an order related to the next task indicators of the tasks, the task launcher, upon launch of a task, executing the action indicated by the next action indicator associated with the launched task.

2. The system of claim 1, wherein one or more of the actions are operable to modify a next action indicator.

3. The system of claim 2, wherein one or more of the actions are operable to modify a next task indicator.

4. The system of claim 3, wherein the task launcher comprises a plurality of task launch points, each task launch point being associated with a respective task.

5. The system of claim 4, further comprising a general purpose computer and a computer readable medium associated with the general purpose computer, wherein each of the tasks comprises one or more computer executable actions stored on the computer readable medium and the task launcher comprises a computer executable routine stored on the computer readable medium.

6. The system of claim 5, wherein each next action indicator comprises a pointer to a respective task launch point and wherein each next action indicator comprises a pointer to an action.

7. The system of claim 3, further comprising a general purpose computer and a computer readable medium associated with the general purpose computer, wherein each of the tasks comprises one or more computer executable actions stored on the computer readable medium and the task launcher comprises a computer executable routine stored on the computer readable medium, wherein the routine comprises the steps of:
(a) launching a first task;
(b) executing an action indicated by the next action indicator associated with the first task;
(c) launching a second task indicated by the next task indicator associated with the first task; and
(d) executing an action indicated by the next action indicator associated with the second task.

8. The system of claim 3, further comprising a hard disc drive having a microprocessor and a memory associated with the microprocessor, wherein each of the tasks comprises one or more microprocessor executable actions stored on the memory and the task launcher comprises a microprocessor executable routine stored on memory, wherein the routine comprises the steps of:
(a) launching a first task;
(b) executing an action indicated by the next action indicator associated with the first task;
(c) launching a second task indicated by the next task indicator associated with the first task; and
(d) executing an action indicated by the next action indicator associated with the second task.

9. The system of claim 8, wherein each of the tasks is cooperative.

10. The system of claim 9, further comprising a preemptive microprocessor executable routine operable to interrupt execution of the task launcher.

11. The system of claim 10, wherein at least one microprocessor executable action comprises program code written in assembly language and the task launcher comprises a microprocessor executable routine written in a high level programming language.

12. A method for dynamically scheduling a plurality of tasks in a data processing system including a processor and an associated memory, each task comprising one or more associated processor executable actions stored in the memory, an associated next action indicator which indicates the location in memory of an action associated with the task, an associated task launch point, and an associated next task indicator which indicates the location in memory of the task launch point associated with the task, the method comprising steps of:
(a) launching a first task;
(b) executing an action indicated by the next action indicator associated with the first task;
(c) launching a second task indicated by the next task indicator associated with the first task; and
(e) executing an action indicated by the next action indicator associated with the second task.

13. The method of claim 12, wherein each next task indicator comprises a pointer to an associated task launch point and wherein each next action indicator comprises a pointer to an associated action.

14. The method of claim 12, wherein:
the launching step (a) comprises branching to an address pointed to by the next action indicator associated with the first task;
the executing step (b) comprises:
(b)(i) executing an action at the address pointed to by the next action indicator associated with the first task; and
(b)(ii) branching to an address pointed to by the next task indicator associated with the first task;
the launching step (c) comprises branching to an address pointed to by the next action indicator associated with the second task; and
the executing step (d) comprises:
(d)(i) pushing a next task indicator associated with the second task;
(d)(ii) executing an action at the address pointed to by the next action indicator associated with the second task; and
(d)(iii) returning to the address pointed to by the next task indicator associated with the second task.

15. The method of claim 12, wherein the data processing system further includes a memory based list-in-first-out stack and wherein:
the launching step (a) comprises:
(a)(i) loading the next action indicator associated with the first task; and
(a)(ii) branching to the address pointed to by the next action indicator associated with the first task;
the executing step (b) comprises:
(b)(i) executing the action at the address pointed to by the next action indicator associated with the first task;
(b)(ii) loading the next task indicator associated with the first task; and
(b)(iii) branching to the address pointed to by the next task indicator associated with the first task;
the launching step (c) comprises:
(c)(i) loading the next action indicator associated with the second task; and
(c)(ii) branching to the address pointed to by the next action indicator associated with the first task; and
the executing step (d) comprises:
(d)(i) pushing the next task indicator associated with the second task;
(d)(ii) executing the code at the location pointed to by the next action indicator associated with the second task; and
(d)(iii) returning to the address pointed to by the next task indicator associated with the second task.

16. The method of claim 12 wherein:
the data processing system further includes a hardware stack, a software stack, an auxiliary register pointer, a first task complete function which sets the auxiliary register to indicate use of the software stack, and a first task complete pointer which points to the first task complete function;
the first task comprises program code written in assembly language;
the second task comprises program code written in a high level programming language;
the launching step (a) comprises:
(a)(i) pushing the next task indicator associated with the first task onto the hardware stack;
(a)(ii) loading the next action pointer associated with the first task; and
(a)(iii) branching to the address pointed to by the next action pointer associated with the first task;
the executing step (b) comprises:
(b)(i) executing the action at the address pointed to by the next action indicator associated with the first task;
(b)(ii) loading the first task complete pointer; and
(b)(iii) branching to the address pointed to by the first task complete pointer and executing the first task complete function;
the launching step (c) comprises:
(c)(i) pushing the next task indicator associated with the second task onto the hardware stack;
(c)(ii) loading the next action pointer associated with the second task; and
(c)(iii) branching to the address pointed to by the next action pointer associated with the second task; and
the executing step (d) comprises:
(d)(i) pushing the next task indicator associated with the second task onto the software stack;
(d)(ii) executing the code at the location pointed to by the next action indicator associated with the second task; and
(d)(iii) returning to the address pointed to by the next task indicator associated with the second task.

17. The method of claim 15, wherein the high level programming language is “C” programming language.

18. The method of claim 12, wherein the data processing system is a hard disc drive and the processor comprises a digital signal processor.

19. The method of claim 18, further comprising a preemptive processor executable routine operable to interrupt execution of the task launcher and wherein each of the tasks is cooperative.

20. A system for scheduling the order of launch of a plurality of tasks in a disc drive:
a microprocessor having an associated memory storing a plurality of tasks; and
a means in the memory for scheduling the launch order of the plurality of tasks.
